(19) United States
(12) Patent Application Publication
(10) Pub. No.: US 2003/0216896 A1
(43) Pub. Date: Nov. 20, 2003

(54) System and method for modeling dynamic systems using large scale parameter estimation

(76) Inventors: John T. Betts, Issaquah, WA (US); William P. Huffman, Issaquah, WA (US)

Correspondence Address: Mark D. Elchuk, Harness, Dickey & Pierce, P.L.C., P.O. Box 828, Bloomfield Hills, MI, 48303, US

(21) Appl. No.: 10/426,322

(22) Filed: Apr. 30, 2003

Related U.S. Application Data
(60) Provisional application No. 60/381,294, filed on May 17, 2002.

(51) Int. Cl. G06F 17/10

(52) U.S. Cl. 703/2

(57) ABSTRACT

A system and method for producing a mathematical model of a dynamic system using a large number of parameters to produce a mathematical model most efficiently. The system uses large numbers of parameters while reducing the need of additional real data from tests and decreasing computational time to reach satisfactory models of the dynamic systems. The system efficiently and precisely computes all matrices that define the dynamic system. In addition, sparse non-linear programming is used to solve, quickly and efficiently, the matrices used by the present invention. Therefore, the method produces a quadratically converging algorithm for solving parameter estimation problems.

### CROSS-REFERENCE TO RELATED APPLICATIONS

This application claims the benefit of U.S. Provisional Application No. 60/381,294, filed on May 17, 2002. The disclosure of the above application is incorporated herein by reference.

### FIELD OF THE INVENTION

The present invention relates to dynamic system modeling, and particularly to dynamic system modeling using a large number of discrete parameters.

### BACKGROUND OF THE INVENTION

Dynamic systems, or systems that change over time, may be described mathematically by ordinary differential equations in the mathematical models. The dynamic systems include trajectories that define at least one path of motion of an item or object moving in the system. Often only a limited number of parameters are used when defining the systems or the trajectories of the object in the systems. An error occurs when a model fails to exactly predict or define a real trajectory of the object. Parameters can be used to solve the models to minimize the errors. A model can be optimized by reducing the errors to zero or within a selected range. A problem arises, however, when attempting to define the parameters that will allow the models to correctly predict a real or measured trajectory of the dynamic system. Generally, it is easier to predict the trajectories with a large number of input parameters. Using a large number of parameters also decreases iterations necessary to optimize the model. Nevertheless, current systems limit the number of usable parameters to decrease or to make more practical the computation time for optimizing the model.

One example of a dynamic system includes simulating the trajectory of an aircraft during flight. Exemplary trajectories include the lift and drag of the aircraft in flight. Flight tests may be performed to determine real or measured trajectories of the aircraft during flight. After flight test data is obtained, a mathematical model is produced using parameters to define model trajectories to substantially match the real trajectories. Specifically, parameters are chosen or determined to allow the models to create a determined trajectory that substantially matches the real trajectories defined by the flight test data. These models are refined and corrected by optimizing the parameters chosen. The less accurately the parameters can be chosen or optimized, the greater the number of flight tests must be used in the modeling process. This is particularly relevant because flight mathematical models are used to define the physical environment of flight simulators for aircraft. Flight simulators are required by the Federal Aviation Administration to certify a new aircraft. The flight simulators must be able to correctly simulate the real trajectories of the aircraft to allow the proper training of pilots. Flight simulators are also used in non-civilian applications to provide training for pilots while not subjecting aircraft to continuous use or to untrained pilots.

Not only can dynamic systems be applied to the flight of aircraft, such as aerodynamic models, they can also be used to define other systems. Dynamic systems also may define flap deflections or the thrust of an aircraft. In addition, dynamic systems may be used to define the travel of other vehicles, such as land vehicles, during motion.

Previous systems, such as the Gauss algorithm, have not provided satisfactory results. In particular, the Gauss algorithm produces particularly large and complex computations. These complex computations provide only linear convergence to minimize the fits of mathematical models to true data. Therefore, very large numbers of parameters cannot be easily or practically computed. Rather, only a limited number of parameters may be used or large residuals must be accepted.

In addition, many systems that use the Gauss algorithm to define a dynamic system simply estimate or use a crude calculation of the Hessian or residual Hessian matrices to solve the computations. This again allows only a linear convergence and does not practically lend itself to calculating models using a very large number of parameters to define the dynamic system.

Therefore, it is desirable to provide a system and method that allows the non-prohibitive computation of mathematical models of dynamic systems. In particular, it is desirable to provide a method and system that allows the inclusion of a large number of parameters to more closely model the dynamics of the system, and produce a model that is more accurate. It is also desirable to provide a system that allows the production of an accurate model, but requires fewer real or tested data points, thereby reducing the cost of producing such models. In addition, it would be desirable to provide a method that uses all quantities of mathematical equations and systems to produce the most accurate and efficient mathematical algorithms to produce models of dynamic systems. As opposed to ignoring mathematical quantities of the equations it is desirable to calculate the system including the previously ignored quantities by calculating them efficiently to optimize the process.

### SUMMARY OF THE INVENTION

The present invention is directed towards an efficient method to produce a dynamic system model. Moreover, the present invention uses a large number of parameters to produce a mathematical model most efficiently. The present invention allows for the use of large numbers of parameters and reduces the need for additional real data from tests. The system decreases computational time to reach satisfactory models of the dynamic systems. The mathematical model produced by the present invention may define the dynamics, such as trajectories of an aircraft, using a generally known equation to define the dynamic systems. The present invention, however, efficiently and precisely computes all matrices that define the dynamic system. In addition, sparse nonlinear programming is used to quickly and efficiently solve the matrices in the present invention. Therefore, the present invention provides for a method that produces a quadratically converging algorithm for solving parameter estimation problems.

First a direct transcription of the parameter estimation problem is made into a nonlinear program (NLP) by discretization. The NLP, which is sparse, can be solved using sequential quadratic programming. Then a least squares calculation is used to determine the accuracy of the approximation of the parameters used in the preceding calculation. This process is then iterated until the residuals have been minimized, thereby providing the most correct parameters that may be used to correctly define the dynamic system.

Further areas of applicability of the present invention will become apparent from the detailed description provided hereinafter. It should be understood that the detailed description and examples, while indicating the various embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow chart of the major steps performed by a dynamic modeling system in accordance with a preferred embodiment of the present invention;

FIG. 2 is a schematic view of a system that performs the method of the present invention and displays a graphical result thereof;

FIGS. 3a-3c are graphs of the percent error for a first example of the present invention; and

FIGS. 4a-4c are graphs of the percent error for a second example of the present invention.

### DETAILED DESCRIPTION OF VARIOUS EMBODIMENTS

The following description of various embodiments is merely exemplary in nature and is in no way intended to limit the invention, its application, or uses. Although the following description relates to any dynamic system and it includes examples to aerodynamic dynamic systems, it will be understood, that the following description may be applied to any dynamic system. For example, the following system may be used to create a model to determine the dynamic system of the motion of a land vehicle, sea vehicle or flight of any object. Therefore, it will be understood, that the examples of an aerodynamic system are intended to be only exemplary and not limiting.

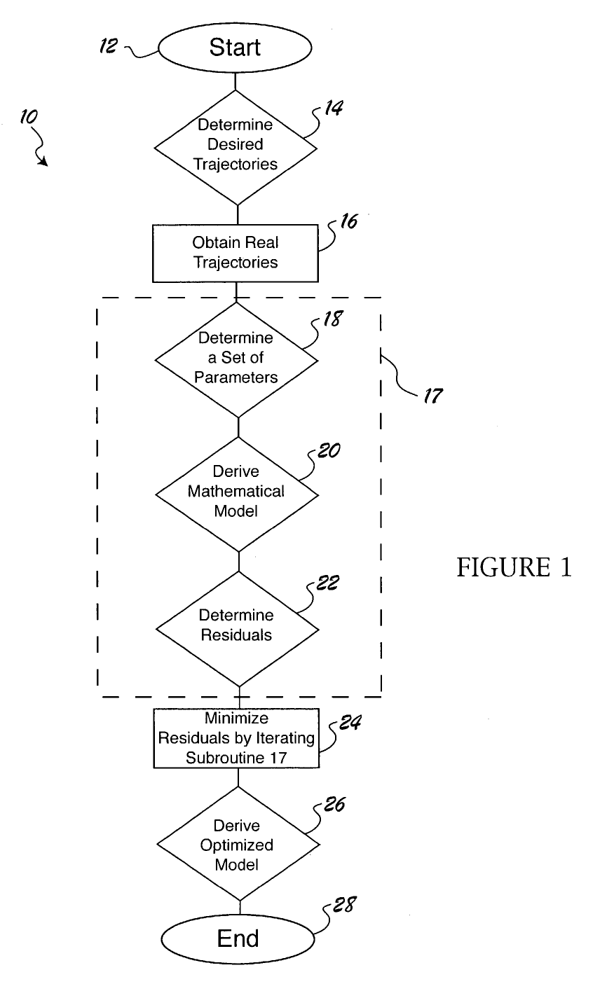

With reference to FIG. 1, a parameter optimization method 10 for implementing a dynamic modeling system in accordance with a preferred embodiment of the present invention is illustrated as a flow chart. The optimization method 10 starts at step 12. Proceeding to the first determination step 14, a determination of the trajectories to be correctly modeled is made. For example, the trajectories of an aircraft during flight may be calculated. Specific aerodynamic trajectories may include those caused by a drag or lift of the aircraft. It will be understood that although the following description refers specifically to trajectories for aircraft, and specifically aerodynamic trajectories, any trajectories of aircraft may be determined. Furthermore, “trajectories” as used herein, refers to any portion of a dynamic system that can be determined using mathematical models with the input of various useful or needed parameters which can be determined with dynamic variables.

After the desired trajectories are determined in step 14, real or test trajectories are obtained in step 16. In particular, a model is known to be competent or most accurate when it can determine actual results with a small degree of error. Therefore, real trajectories are obtained and the determined or model trajectories are compared to the real trajectories to determine if the model is optimal or accurate.

After obtaining the real trajectories in step 16, an iterative subroutine 17 is entered. A first set of parameters are determined in step 18. To perform the calculations, to be described further herein, a first set of estimated parameters must be determined. These estimated parameters are then optimized by iterating subroutine 17.

The first set of estimated parameters are then used to derive the mathematical models, in step 20, including the first estimated parameters from step 18. These models are then used to derive a first set of determined trajectories, that attempt to model the real trajectories obtained in step 16. The models are then compared to the real trajectories to determine the difference between the model derived in step 20 and the real trajectories obtained in step 16. The determination, in step 22, produces a residual. The residual is the difference between the real trajectories obtained in step 16 and the model trajectories determined at step 20.

After the residuals are determined in step 22, it is determined whether the least squares of the residuals are or can be further minimized in step 24. Minimizing the residuals requires iterating through iterative subroutine 17 until the residuals from step 22 are minimized or can be reduced no more. If the residuals for the last iteration of subroutine 17 are smaller than the previous iteration of subroutine 17 then another iteration is performed with a new set of estimated parameters. In particular, an iteration involves performing the subroutine 17, including determining the set of parameters, as in step 18; determining the mathematical model, as in step 20; and determining residuals, as in step 22. After each iteration, the parameters are re-estimated in an attempt to minimize the squares of the residuals. Therefore with each iteration the model 10 decreases the residuals, thereby increasing the accuracy of the mathematical model 10. In step 24, the residuals are minimized to the smallest possible or most reasonably small amount, thereby creating a best possible mathematical model. In determining the mathematical model 10, a first set of parameters are estimated or guessed to be used for the first iteration. After the first set of parameters are calculated, the mathematical model 10 can be iterated to create the residuals which are minimized in step 24. The parameters that are determined when the residuals are minimized are substantially optimized parameters. The optimized parameters are the parameters that are determined which best define the dynamic system by producing the minimized residuals between the solutions of the determined equations and the obtained data. Therefore, although a plurality of parameters are determined and obtained during the iterative steps of the mathematical model 10, the optimized parameters are those parameters which produce the minimized residuals. The optimized parameters are also the most correct parameters determined by the mathematical model 10. In particular, when the residuals are minimized in step 24, the mathematical model determined in step 20 substantially models the real trajectories obtained in step 16.

When the squares of the residuals have been minimized, that is when a minimized least squares of the residuals has been determined, an optimized model is produced at step 26. The optimized model uses the last set of parameters determined in the iterative subroutine 17. Thus, the optimized model may most precisely predict the real trajectories. The optimized models are able to very closely simulate the real trajectories obtained in step 16 of an actual aircraft. Physical characteristics of a real aircraft may then be determined using the optimized model in the simulator.

The present invention efficiently performs parameter estimation and optimization. Parameter optimization may proceed through a linear convergence that includes much computational time and complexity to determine optimized parameters. The estimation of the parameters is continually improved to optimize the estimated parameters to produce the best models. Nevertheless, the present invention does not necessarily require only linear convergence.

The dynamics for a system are generally defined for times between the initial or start time and a final time. The dynamics are defined by a set of differential equations generally referred to as state equations, such as these defined in Equation 1:

\dot{y}=f[y(t),u(t),p,t] EQUATION 1

wherein y is an n_{y} dimension state vector and u is an nᵤ dimension vector of algebraic variables, p is a of parameter or set of parameters of the system, and t is a time. As used herein a variable augmented with a dot over the variable represents the time differential of the function. Generally, bounds are placed on the state variables. For example, the variables p are bound between pₗ and Pᵤ.

The basic parameter estimation problem is to determine the nₚ—dimensional vector p to minimize the performance index:

$$F = \frac{1}{2} {r}^{T} r \qquad EQUATION 2$$

where r is the l-dimensional residual vector. Equation 2 is the general form of the function of the residuals to be minimized to produce the best fit model. Components of the residual vector can be of two forms. State residuals are of the form:

rₖ=w_{if}└yᵢ(θ_{if})−ŷ_{if}┘ EQUATION 3

where yᵢ (θᵢⱼ) is the value of state variable i computed at θᵢⱼ and ŷᵢⱼ is the observed value at the same point. Algebraic residuals are in the form:

rₖ=wᵢⱼ└uᵢ(θᵢⱼ)−ûᵢⱼ┘ EQUATION 4

where uᵢ (θᵢⱼ) is the value of algebraic variable i computed at time θᵢⱼ while ûᵢⱼ is the observed value at the same point. The term wᵢⱼ in both Equations 3 and 4 is a weight given to the residuals, and may differ for each residual. In this way different residuals can be weighted depending upon their importance to the system. Equation 2, where the state residuals are defined by Equation 3, is the basic form of the functions of the residuals, which are to be minimized according to the present invention. It will be understood that these general equations may be applied to any system to produce a function of the least squares residuals. The description herein is merely exemplary of the functions to produce a least squares optimization function. The present invention may be used to describe or form an optimized model for any dynamic system. The parameters included herein are merely exemplary.

In modeling a dynamic system, the following Equation 5 may be used:

$${H}_{L} ( x , λ ) = {\sum }_{i = 1}^{l} {r}_{i} {∇}^{2} {r}_{i} - {\sum }_{i = 1}^{m} {λ}_{i} {∇}^{2} {c}_{i} + {R}^{T} R \qquad EQUATION 5$$

Equation 5 is used in the estimation of the parameters to define the trajectories or real dynamics of the system. H_{L} is the Hessian of the Lagrangian, also referred to as H, which is a matrix that defines the curvature of an objective function. The objective function may be any function that is being optimized. In Equation 5 rᵢ is the residual vector. ∇²rᵢ is the Hessian of rᵢ, λᵢ is the Lagrange multiplier, and ∇²cᵢ is the corresponding Hessian of the constrain cᵢ. R^{t}R is generally referred to as the normal matrix and is a portion of the residual Jacobean matrix. Equation 5 can also be written as follows:

H_{L}=V+R^{T}R. EQUATION 6

where V is the residual Hessian. According to the present invention, matrix V is determined exactly or precisely such that minimization of Equation 2 can converge quadratically. If matrix V is set to zero, then the function will converge only linearly, therefore, the computation of models with large numbers of parameters is impractical. Precisely determining matrix V helps limit the computational time to correctly model the system.

Solving linear systems that involve matrix H may be calculated using linear algebra. This is made possible by making the matrix H sparse. This is done by determining the set of variables chosen. Preferably a system may be defined by a set of variables which are affected by their respective nearest neighbors in the function alone. Therefore, the remaining matrix variables are zero, thus it is sparse. This allows linear algebra to efficiently compute the matrix. This is particularly helpful when the measured coefficients do not interact with one another. Matrix H is sparse so that a sparse non-linear program can be used to solve them in an efficient and quick manner. An appropriate program to calculate the sparse matrix is BCSLIB-EXT® produced by The Boeing Company. Therefore, linear algebra can be used to efficiently solve systems involving the matrix H thereby permitting the optimization to converge quadratically rather than linearly, thereby decreasing the computational time to optimize the parameters.

### Modeling Aerodynamic Systems

One application where determining models of dynamic systems is inherently important is in designing flight simulator models. In the simulators the simulated aircraft must respond as closely as possible to a real aircraft. In a flight simulator, individuals are able to interact with a viewable display that displays simulated the flight of an aircraft. Generally, input from the individual is used to compute flight of the aircraft due to input of the individual and simulated environmental factors, such as wind speed, and air temperature. The models created for the flight simulators must be able to substantially simulate the actual flight of an aircraft given the human input and the simulated environmental conditions. Therefore, the models and the computer must be able to quickly compute the flight of the aircraft in regards to the human input and the simulated environmental factors. Also, it is desirable to efficiently and quickly determine optimized models.

To do this, the mathematical model must include parameters that can substantially predict or mimic real trajectories of the aircraft within the simulated system. Generally, as a part of creating the mathematical models, the models predict trajectories, using selected parameters, that are then evaluated and tested in flight tests. Reducing the number of iterations required to produce models as substantially mimic real flight trajectories reduces the cost and time of producing flight simulation programs. Therefore, creating models as accurately and as quickly as possible is reduces time and expense. Parameters are chosen to define the real world in the simulator system. These parameters are unknown and must be determined for the model.

The error between a model and a real dynamic system is defined by the residuals between the modeled system and the real system. To minimize the error in an aerodynamic system, that is to produce the least square residuals, is to minimize the function of the residuals of the model with a particular set of determined parameters defined by Equation 7:

$$F = \frac{1}{2} {\sum }_{i = 1}^{3} {\sum }_{j = 1}^{N} {\sum }_{k = 1}^{6} {\{ \frac{1}{{s}_{k}} [ {y}_{k}^{( i )} ( {θ}_{k j} ) - {\hat{y}}_{k j}^{( i )} ] \}}^{2} \qquad EQUATION 7$$

where F is a function of p, Fₚ. When Equation 7 is substantially minimized or is minimized to a selected amount, the residuals and the systems are optimized. Each successive iteration includes new p, or p bar, which is old p plus Δp. Solving the matrix H, which includes matrix V described herein, produces Δp. In particular, matrix H defines the function F of Equation 7. The matrix H is used to optimize Equation 7 for aerodynamic systems. Therefore, if Fₚ, which is the solution of Equation 7 after the last iteration, is less than the Fₚ bar, which is the solution of Equation 7 at the iteration of the second to last iteration, then Equation 7 has not been minimized. When Fₚ bar=Fₚ, Equation 7 has been minimized. Nevertheless, Fₚ bar need not equal Fₚ rather, a selected change may have occurred that is small enough to be considered optimized. Also, the Equation 7 is a functional of several elements k, j, i. Generally, k is indicative of the dynamic of variables defined by Equation 16-21. The function also sums errors j over n data points and three distinct trajectory phases L are also included. Therefore, the initial estimation of the parameters is determined as in step 18. These initial parameters are placed into equations 8-11:

$$D = \frac{1}{2} {C}_{D} S ρ {v}^{2} \qquad EQUATION 8$$

Where D is drag and Equation 8 is the function of drag of an aircraft and a flight trajectory. C_{D} is the aerodynamic drag co-efficient, S is the cross reference area of the vehicle, v is the velocity.

$$L = \frac{1}{2} {C}_{L} S ρ {v}^{2} \qquad EQUATION 9$$

Equation 9 is a function that defines the lift L of the vehicle. Cₗ is the aerodynamic lift co-efficient.

C_{L}=cₜ(M)α EQUATION 10

Equation 10 defines a function of the aerodynamic lift co-efficient that includes “true” aerodynamic function, M is a function of velocity and alpha is angle of attack and radius.

C_{D}=c_{d}(M)+η(M(cₜ(M)α² EQUATION 11

Equation 11 is the co-efficient of drag which includes “true” aerodynamic drag of the system and η is a non-dimensional scale factor.

Equations 8-11 produce an initial set of determined trajectories. These initial trajectories ŷₖⱼ⁽ⁱ⁾ are then placed into equation 7 along with the real trajectories yₖ⁽ⁱ⁾(θₖⱼ), obtained in step 16, to determine the residuals or Fₚ. The calculation of the residual Hessian matrix determines a Δp that can be used to determine the next p bar to calculate Fₚbar. The next p bar is then used to calculate Equations 8-11 and Equation 7 is recalculated to determine the next Fₚbar which should be smaller than Fₚ. Iterating the process several times reduces the residuals and is the minimization of least square residuals as illustrated in determination step 24.

### EXAMPLES

Many dynamic quantities such as altitude, longitude, latitude, angle of attack, velocity, flight path angle, and azimuth are used when defining a dynamic system. In particular, this example determines the aerodynamic forces of drag D, defined by Equation 8, and lift L defined by Equation 9. Determining drag requires finding the drag coefficient C_{D} which is defined by Equation 11 while lift includes the coefficient of lift C_{L} which is defined by Equation 10. Both coefficients require the calculation of the Mach number M which is defined by Equation 12 as follows:

M=v/v_{c}(h) EQUATION 12

In Equation 12, M is a function of the velocity v and the speed of sound v_{c}(h). The factor η(M) is also required to determine the coefficient of drag.

Generally, M, cₗ, C_{d}, and η(M) are determined in tabular form. In particular, they are predetermined and simply inserted into the equations. Each of these can also be determined using Equations 13, 14 and 15 as follows:

$$\begin{matrix} {c}_{l} ( M ) = {\sum }_{k = 1}^{L} {p}_{l , k} {B}_{k} ( M ) = {p}_{l}^{T} B ( M ) & EQUATION 13 \\ {c}_{d} ( M ) = {\sum }_{k = 1}^{L} {p}_{d , k} {B}_{k} ( M ) = {p}_{d}^{T} B ( M ) & EQUATION 14 \\ η ( M ) = {\sum }_{k = 1}^{L} {p}_{η , k} {B}_{K} ( M ) = {p}_{η}^{T} B ( M ) & EQUATION 15\end{matrix}$$

Each of the Equations 13-15 can be determined using cubic spline polynomial representations. That is where a portion of the function of parameters is splined and defined by a cubic polynomial. B(M) is the B-spline basis function corresponding to the respective coefficients. The coefficients are summed over the spline function representation of the coefficient. Where pl, pd, and p_{η} are the parameters, which are the coefficients for the respective functions, and are to be determined and optimized in the present example to determine the aerodynamic trajectories of the drag and lift. It will be understood that although only drag and lift are determined in this example, any trajectory may be determined using the present invention.

Returning to Equation 7, ŷ are the values for the flight test data and i is a trajectory over which the flight test or real data is collected that defines the real trajectory. Here the summation includes three (3) separate or different trajectories. The variable portion j relates to the number of data points along each trajectory. For this example 1000 data points for each trajectory were determined. Finally, k relates to the differential equations of the dynamic variables that were measured in the test. Here, equation 7 has 6 dynamic variables. The other variable yₖ⁽ⁱ⁾ (θₖⱼ) relates to the simulated values at time points θₖⱼ. The differential equations defining the dynamic variables are:

\dot{h}=vsinγ EQUATION 16

$$\begin{matrix}\dot{φ} = \frac{v cos γ sin ψ}{r cos θ} & EQUATION 17 \\ \dot{θ} = \frac{v}{r} cos γ cos ψ & EQUATION 18 \\ \dot{v} = \frac{{g}_{0} }{\tilde{w}} [ T cos \tilde{α} - \frac{1}{2} ( {c}_{d} + η {c}_{l} {\tilde{α}}^{2} ) S ρ {v}^{2} ] - g sin γ & EQUATION 19 \\ \dot{γ} = \frac{{g}_{0} cos \tilde{β}}{\tilde{w} v} [ T sin \tilde{α} + \frac{1}{2} {c}_{l} \tilde{α} S ρ {v}^{2} ] + cos γ [ \frac{v}{r} - \frac{g}{v} ] & EQUATION 20 \\ \dot{ψ} = \frac{{g}_{0} ( T sin \tilde{α} + \frac{1}{2} {c}_{l} \tilde{α} S ρ {v}^{2} ) sin \tilde{β}}{\tilde{w} v cos γ} + \frac{v cos γ sin ψ sin θ}{r cos θ} & EQUATION 21\end{matrix}$$

In the above equations, h is altitude, φ is longitude, θ is latitude, v is velocity, γ is flight path angle, and ψ is azimuth. Together these are solved to define a continuous trajectory. The other variables include α which is the angle of attack, W which is the weight, β which is the bank angle, D(M) is the drag, G(R) is the acceleration due to gravity, T(M, H) is the thrust, L(M) is the lift force, and r is the radius of the trajectory, such as the flight of an aircraft in an arc.

The difference between the simulated data and the real data gives the residuals. These residuals are squared then summed to determine the square residuals. It is the optimizing of the parameters for Equation 7, the function of the sum of the residuals, which reduces the square residuals to a least square residual. Optimizing the parameters or re-estimating them to optimize Equation 7 provides the best fit model. When Equation 7 reaches the least square residuals, then the parameters, which are placed into the Equations 8-11, have been optimized and produce the best aerodynamic model. Therefore, the parameters p=(pₗ, P_{d}, p_{η}), that define an aerodynamic system, may be determined when using the dynamic variables of altitude, longitude, latitude, velocity, flight path angle and azimuth.

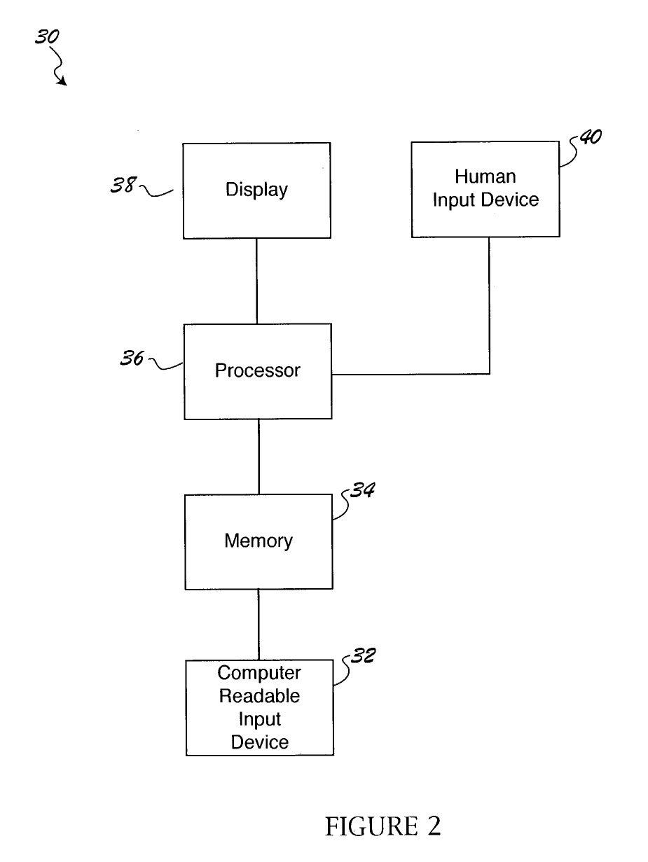

As mentioned above, one use for the present invention is to produce a flight simulator which uses the optimized parameters to define the flight of an aircraft during the simulated flight. With reference to FIG. 2, a computer system 30, such as a flight simulator, generally includes a computer readable input device 32 which allows data collected to be input into a memory core 34. In particular, the real trajectories obtained in step 16, as discussed above, can be input into the memory core 34, generally via a processor 36.

The data input may be the optimized model, created in step 26, or data to allow the processor 36 to form the optimized model. The processor 36 may perform the subroutine 17, minimizing the residuals as in step 24, and deriving the optimized model as in step 26. Therefore, the processor 36 may determine the set of parameters which optimizes the model such that the model most accurately fits the real trajectories which have been stored in the memory 34. After the optimized model has been created by the processor 36 it is encoded in computer executable format.

The model may also be used to display a simulated reality on a display 38. In addition, a person using the computer system 30 may provide human input through a human input device 40 to change the display 38 which is produced by the processor 36. For example, if the system is a flight simulator, then the computer system 30 would allow a human to view the display 38 and simulate controls of an aircraft which is being displayed on the display 38. Therefore, the human input device 40 may, for example, be a flight control stick and related control mechanisms to control a real aircraft.

Therefore, the human may use human input device 40 to input control actions into the processor 36. The processor 36 uses the inputs and displays a simulated world on display 38. The display 38 gives real time visual feedback of how a dynamic system, such as the flight of an aircraft, reacts in the real world to the input without requiring inputs made in a real aircraft. In this way, an individual may learn how the dynamic system would operate in the real world on the simulated world in the computer system 30.

### Example Data I

This example used the above definition of dynamic variables and aerodynamic trajectories to test the present method. Test data was used, that defined an exemplary flight path. Noise was also produced by adding a semi-random variable, σ. According to this example, N=1000 and the total number of residuals calculated in equation 7 was 18,000. The least square of Equation 7 is F=3.6×10⁻¹³. It took thirteen iterations to minimize Equation 7 in this example to produce F.

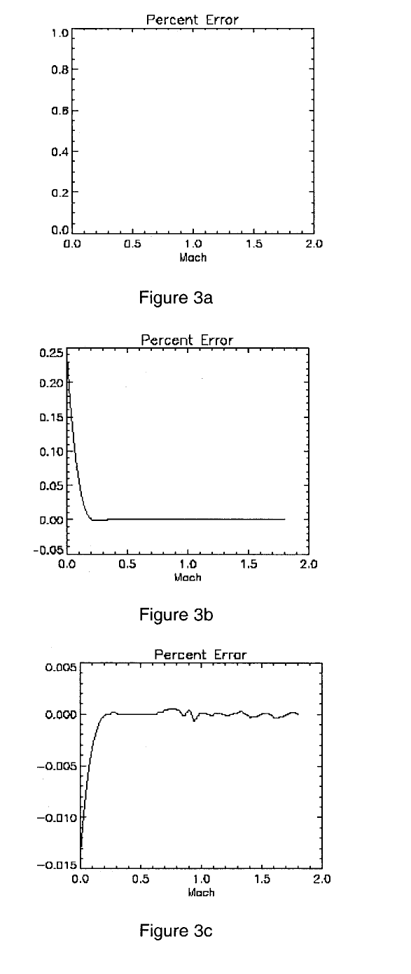

In addition, with reference to FIGS. 3a through 3c, the percent error over the Mach numbers is illustrated. With reference to FIG. 3a, it can be seen that the percent error for the coefficient of lift is negligible. With reference to FIG. 3b, the percent error for the coefficient of drag is negligible over most of the Mach numbers. The percent error is only about 0.2% when the Mach number is zero. In real data, an aircraft never has a Mach number of zero because it must be moving to be in flight. Finally, with reference to FIG. 3c, the percent error for η(M) is also negligible and only has a non-negligible value when the Mach number is nearly zero.

### Example Data II

Even when noise or impreciseness is added to the data to better represent real data, the present invention produces a model that substantially fits the real trajectories measured. For example, even when σ equals 0.01, which defines an error of approximately +/−2500 ft and a velocity error of approximately +/−55 ft per second, F=0.9 for Equation 7. This is determined with only 16 iterations. When using such noisy data, the computations were also constrained. Where the constraints help define the asymptotic behavior of the desired aerodynamic curves, especially where there is not data, that is when the Mach number is near zero. The constraints may constrain the coefficients, or any aspect of the system desired to be controlled, in an appropriate manner depending upon the system being described. It is understood that any calculations may be constrained to better define the curves.

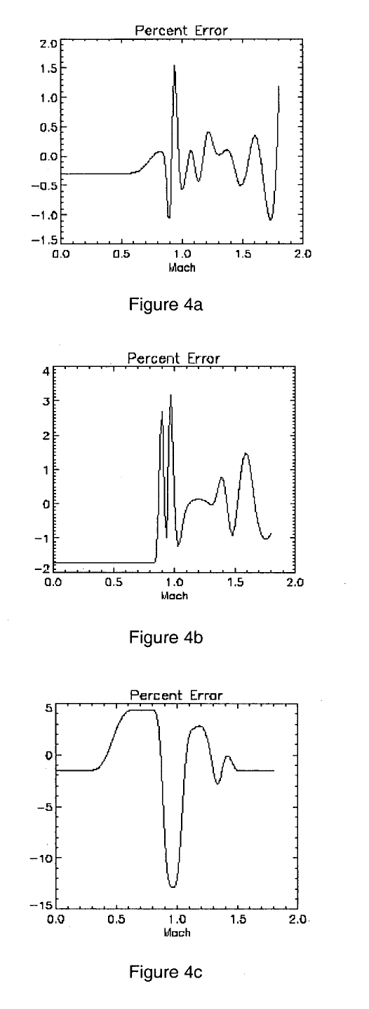

With reference to FIGS. 4a through 4c, the percent error for each of the parameters is illustrated when the noisy data was used. Specifically, FIG. 4a illustrates the percent error of the coefficient of lift over the various Mach numbers. FIG. 4b illustrates the percent error of the coefficient of drag over the test data of Mach numbers. Finally, FIG. 4c illustrates the percent error of η(M) over the Mach numbers of the data. Although the percent error for the noisy data is higher than for the non-noisy data it is still quite acceptable. The percent error for the coefficient of lift is never over 1.5% and the coefficient of drag is never more than 3%. Even the percent error for η(M) is only about 13% at its worst.

Therefore, the present invention is able to provide a method to efficiently estimate parameters which precisely model real or test data. In particular, the parameters can be determined with a relatively few number of iterations while substantially and precisely modeling real test data.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method to optimize parameters for determining trajectories in a dynamic system, the method comprising:
obtaining test data regarding the dynamic system
determining an equation to define the dynamic system, wherein said equation includes a plurality of parameters;
determining a plurality of parameters for said equation to define the dynamic system, wherein the difference between the equation and the test data comprises a residual term; and
minimizing the residual term by determining an optimized plurality of said parameters, wherein a Hessian matrix is calculated.

2. The method of claim 1, further comprising;
determining an optimized model defining the dynamic system including said optimized plurality of parameters; and
encoding said optimized model into a computer readable code such that a computer program may interpret said encoded optimized model to define a simulation of the dynamic system.

3. The method of claim 2, further comprising:
using a processor to process said encoded optimization model; and
using an output device to display said process, wherein said output displays a substantially accurate simulation of the dynamic system.

4. The method of claim 1, wherein obtaining test data includes:
producing the dynamic system in reality; and
measuring at least one variable of the dynamic system produced in reality.

5. The method of claim 4, wherein determining an equation to define the dynamic system includes determining a system to substantially define a trajectory of an object in the dynamic system.

6. The method of claim 5, wherein said most correct plurality of said parameters are used to solve said determined equation to substantially minimize the residual term thereby creating an optimized model.

7. The method of claim 1, wherein determining a plurality of parameters includes determining a plurality of parameters substantially equivalent to parameters obtained during said obtaining test data, wherein said determining a plurality of parameters are used in said equation to define the dynamic system.

8. The method of claim 1, wherein minimizing the residual term includes determining said most correct plurality of said parameters such that said equation when including said most correct plurality of said parameters substantially mimics said obtained test data.

9. The method of claim 2, wherein said determining an optimized model includes minimizing said residuals such that most correct plurality of parameters substantially mimic said obtained test data when used to solve said determined equation.

10. A system to display a simulated dynamic system comprising:
a computer processable program to calculate trajectories of an object in a real dynamic system, wherein said computer processable program includes:
an equation to define the trajectories of a system;
a parameter of the equation that is optimized to define the real dynamic system;
a Hessian matrix to provide a change to said parameter;
wherein when said Hessian matrix is used to determine an optimized parameter;
a processor to process said computer processable program; and
a memory storage system to store said parameters.

11. The system of claim 10, further comprising:
a display to display the simulated dynamic system that simulates the real human viewable dynamic system; and
wherein said display includes a graphic representation of said object.

12. The system of claim 10, wherein said equation substantially defines said real dynamic system for processing by said processor.

13. The system of claim 10, wherein said parameter is used with said equation to substantially mimic said real dynamic system for display on said human viewable display.

14. The system of claim 10, wherein said optimized parameter is used to solve said equation to define a substantially optimized model;
wherein said substantially optimized model substantially mimics said real dynamic system for display on said human viewable display.

15. The system of claim 10, wherein said optimized parameter is determined with said Hessian matrix to substantially reduce a number of iterations required by said processor to determine said optimized parameter.

16. The system of claim 10, wherein said computer processable program includes a subroutine including:
determining a first set of parameters;
deriving a mathematical model using said first set of parameters to substantially mathematically define said real dynamic system;
determining a residual between said derived mathematical model and said real dynamic system with said first set of parameters;
wherein said determined residual is substantially minimized to determine said optimized parameter.

17. The system of claim 16, wherein said processor determines said residuals by comparing the difference between said first set of parameters and a set of real parameters and a second set of parameters and said real parameters;
wherein said real parameters are stored in said memory system and said second set of parameters is the last set of determined parameters.

18. A method to substantially accurately model a dynamic system comprising:
(a) obtaining data which measures the dynamic system;
(b) determining an equation to define the dynamic system including a Hessian matrix;
(c) determining a first parameter to calculate said equation, wherein a residual term is produced when using said first parameter to solve said determined equation that defines the difference between said obtained data and said solved determined equation;
(d) calculating said Hessian matrix to produce a second parameter; and
(e) minimizing said residual term to determine an optimized parameter by repeating steps (c) and (d), wherein said second parameter becomes said first parameter after completing step (d).

19. The method of claim 18, wherein said determining an equation includes selecting an equation that generally defines said obtained data.

20. The method of claim 18, wherein said first parameter is used to obtain a determined solution using said determined equation to substantially match said obtained data;
wherein minimizing said residual term includes reducing a difference between said determined solution and said obtained data.

21. The method of claim 18, wherein minimizing said residual term includes determining said second parameter to be used in said determined equation to substantially determine said obtained data with only said second parameter and said determined equation.

22. The method of claim 18, wherein said calculating Hessian matrix allows for minimizing said residual in a substantially quadratic manner.

23. The method of claim 18, wherein said calculating Hessian matrix substantially minimizes the number of times of said repeating steps (c) and (d) to determine said optimized parameter.
